(19) United States
(12) Patent Application Publication
(10) Pub. No.: US 2025/0139234 A1
(43) Pub. Date: May 1, 2025

(54) System to Detect Exploitation of an AI Model and a Method Thereof.

(71) Applicants: Robert Bosch GmbH, Stuttgart (DE); Bosch Global Software Technologies Private Limited, Koramangala (IN)

(72) Inventors: Manojkumar Somabhai Parmar, Ahmedabad (IN); Govindarajulu Yuvaraj, Bengaluru (IN); Pavan Kulkarni, Karnataka (IN); Gauri Bhardwaj, Bangalore (IN)

(21) Appl. No.: 18/928,585

(22) Filed: Oct. 28, 2024

(30) Foreign Application Priority Data
Oct. 31, 2023 (IN) 2023 4107 4063

(51) Int. Cl. G06F 21/55

(52) U.S. Cl. CPC G06F 21/55; G06F 2221/034

(57) ABSTRACT

A system to detect exploitation of an AI model and a method thereof is disclosed. The system includes an AI model, a transformation module, a media to text AI model, and at least a processor. The AI model is configured to receive an input prompt and generate a visual media output. The transformation module is configured to transform the visual media output into a plurality of secondary outputs. The media to text AI model is configured to process the plurality of secondary outputs and generate a plurality of tertiary outputs. The processor is configured to perform comparative analysis on the tertiary outputs and the received input prompts to detect exploitation on the AI model.

This application claims priority under 35 U.S.C. § 119 to patent application no. IN 2023 4107 4063, filed on Oct. 31, 2023 in India, the disclosure of which is incorporated herein by reference in its entirety.

The present disclosure relates to the field of Artificial Intelligence security for generative AI models. In particular, the present disclosure proposes a method to detect exploitation of a text to visual output-based AI model in an AI system.

### BACKGROUND

With the advent of data science, data processing and decision making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically, the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The models in the AI systems form the core of the system. Lots of effort, resources (tangible and intangible), and knowledge goes into developing these models.

Generative AI models are capable of generating text, images, or other media. Recent technological developments in the area of generative AI and what are known as foundation models (such as ChatGPT) pose new opportunities and challenges. These models are able to generate content such as software code, text, images, and music. What makes them especially powerful compared to previous AI models is that they are trained on vast amounts of data. In the recent times a number of generative AI systems notable for accepting natural language prompts as input have come up. These include large language model chatbots such as ChatGPT, Bing Chat, Bard, and LLaMA, and text-to-image AI art systems such as Stable Diffusion, Midjourney, and DALL-E.

Text-to-Image generation is a unique area in the Computer Vision domain, although several attacks have been explored, not many defense methods are explored. Attackers, through various techniques such as crafting adversarial data (poisoning) or finding adversarial examples, pose a significant threat to the integrity and reliability of such AI systems. Conventional approaches relying on a single model for predictions are vulnerable to targeted attacks, making it imperative to explore more robust security measures. In this s disclosure we propose a robust framework/system and method to detect attacks on such AI models configured to receive an input prompt and generate a visual media output.

### BRIEF DESCRIPTION OF THE DRAWINGS

An embodiment of the disclosure is described with reference to the following accompanying drawings:

FIG. 1 depicts a system to detect exploitation of an AI model;

FIG. 2 illustrates method steps (200) to detect exploitation of an AI model.

### DETAILED DESCRIPTION

It is important to understand some aspects of artificial intelligence (AI) technology and artificial intelligence (AI) based systems. Some important aspects of the AI technology and AI systems can be explained as follows. Depending on the architecture an AI systems may include many components. One such component is an AI model. An AI module with reference to this disclosure can be explained as a component which runs a model. A model can be defined as reference or an inference set of data, which uses different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. A person skilled in the art will also appreciate that the AI model may be implemented as a set of software instructions or a hardware (such as neural network chips) or a combination of software and hardware of the same.

Some of the typical tasks performed by AI systems are classification, clustering, regression etc. Majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. Clustering or grouping is the detection of similarities in the inputs. The cluster learning techniques do not require labels to detect similarities. Learning without labels is called unsupervised learning. Unlabeled data is the majority of data in the world. One law of machine learning is: the more data an algorithm can train on, the more accurate it will be. Therefore, unsupervised learning models/algorithms has the potential to produce accurate models as training dataset size grows.

In Model Extraction Attacks (MEA), the attacker gains information about the model internals through analysis of input, output, and other external information. Stealing such a model reveals the important intellectual properties of the organization and enables the attacker to craft other adversarial attacks such as evasion attacks. The attacker typically generates random queries of the size and shape of the input specifications and starts querying the model with these arbitrary queries. This querying produces input-output pairs for random queries and generates a secondary dataset that is inferred from the pre-trained model. The attacker then take this I/O pairs and trains the new model from scratch using this secondary dataset. This is black box model attack vector where no prior knowledge of original model is required. As the prior information regarding model is available and increasing, attacker moves towards more intelligent attacks. The attacker chooses relevant dataset at his disposal to extract model more efficiently. This is domain intelligence model-based attack vector. With these approaches, it is possible to demonstrate model stealing attack across different models and datasets.

In general AI adversarial threats can be largely categorized into-model extraction attacks, inference attacks, evasion attacks, and data poisoning attacks. In Model Extraction Attacks (MEA), the attacker gains information about the model internals through analysis of input, output, and other external information. Stealing such a model reveals the important intellectual properties of the organization and enables the attacker to craft other adversarial attacks such as evasion attacks. The attacker typically generates random queries of the size and shape of the input specifications and starts querying the model with these arbitrary queries. This querying produces input-output pairs for random queries and generates a secondary dataset that is inferred from the pre-trained model. The attacker then take this I/O pairs and trains the new model from scratch using this secondary dataset. This is black box model attack vector where no prior knowledge of original model is required. As the prior information regarding model is available and increasing, attacker moves towards more intelligent attacks. The attacker chooses relevant dataset at his disposal to extract model more efficiently. This is domain intelligence model-based attack vector.

In poisoning attacks, the adversary carefully injects crafted data to contaminate the training data which eventually affects the functionality of AI based system. Since generative AI models rely on extensive and diverse training dataset, they are very prone to poisoning attacks. Inference attacks attempt to infer the training data from the corresponding output or other information leaked by the target model. Studies have shown that it is possible to recover training data associated with arbitrary model output. In evasion attacks, the attacker works on the AI algorithm's inputs to find small perturbations leading to large modifications of its outputs (e.g, decision errors) which leads to evasion of the AI model. Since generative AI models are deployed in open environments that expose them to diverse and large number of inputs, they are prone to evasion attacks.

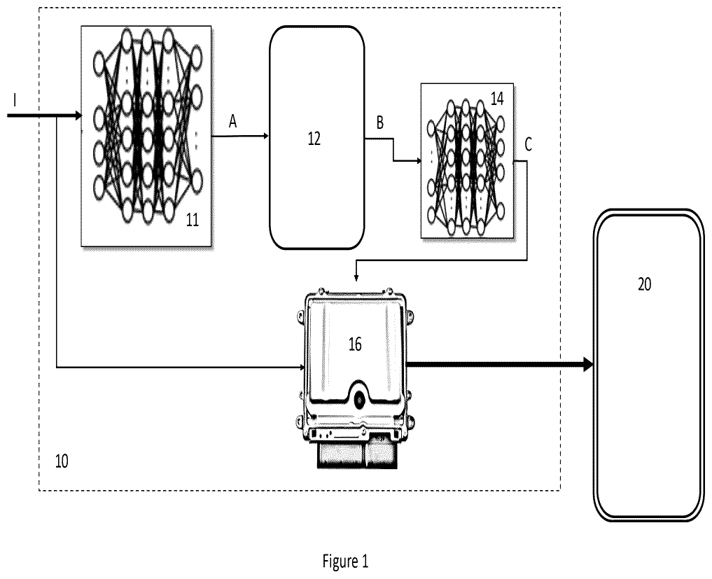

FIG. 1 depicts a system (10) to detect exploitation of an AI model (11). The system (10) comprises an AI model (11), a transformation module (12), a media to text AI model (14) and at least a processor (16).

The output of the system (10) may be displayed on an output interface (20). It must be understood that each of the component of the system (10) may be implemented in different architectural frameworks depending on the applications. In one embodiment of the architectural framework all the components of the system (10) are implemented in hardware i.e. each building block may be hardcoded onto a microprocessor chip. This is particularly possible when the components are physically distributed over a network, where each component is on individual computer system across the network. In another embodiment of the architectural framework of the system, the components are implemented as a combination of hardware and software i.e. some building blocks are hardcoded onto a microprocessor chip while other building block are implemented in a software which may either reside in a microprocessor chip or on the cloud.

The AI model (11) is a generative AI model that is configured to receive an input prompt (I) and generate a visual media output. Such AI models take a natural language description as an input and produces an image or a video matching that description. Some well-known text to media AI generators are Jasper.ai Art, Dall-E, Midjourney, Stable Diffusion, Starry AI etc.

The transformation module (12) is configured to transform the visual media output (A) into a plurality of secondary outputs. The transformation module (12) can perform transformations which include but are not limited to at least one or more of the spatial, pixel, random additive noise transformation. Spatial transformations include rotating, skewing, scaling the visual media output. In the pixel transformations the color, hue, saturation of the visual media output (A) is transformed. In random additive noise transformation, a calculated noise is added across all pixels in the visual media output.

The media to text AI models (14) are also known as reverse captioning models. They try to generate captions/description of the image/video inputs fed to them. The media to text AI model (14) is configured to receive the plurality of secondary outputs (B) generated by the transformation module (12). They process the plurality of secondary outputs to generate a plurality of tertiary outputs (C). The tertiary outputs (C) comprise textual description of the visual media in the secondary output.

The processor (16) is a logic circuitry or a software programs that respond to and processes logical instructions to get a meaningful result. A hardware processor (16) may be implemented in the system (10) as one or more microprocessors, microcomputers, microcontrollers, digital signal processors, central processing units, state machines, logic circuitries, one or more microchips or integrated circuits interconnected using a parent board, hardwired logic, software stored by a memory device and executed by a microprocessor, firmware, an application specific integrated circuit (ASIC), and/or a field programmable gate array (FPGA), and/or any component that operates on signals based on operational instructions. In the present disclosure the processor (16) incorporates a comparator. The comparator can be a conventional electronic comparator or specialized electronic comparator either embedded with neural networks or executing another AI model to enhance their functions.

The processor (16) is configured to perform comparative analysis on the tertiary outputs C (i.e. textual description of the visual media in the secondary output) and the received input prompts (I). The processor (16) detects exploitation on the AI model based on the comparative analysis. The underlying concept is further elucidated with help of method steps (200). While performing the comparative analysis it uses a multi-label classifier that is trained classify the multi-labels based on the important key words in the textual description and the input prompts (I). The processor is further configured to perform loss calculation, word error rate and similarity measure on the textual description and input prompts (I).

As used in this application, the terms “component,” “model,” “module,” “interface,” are intended to refer to a computer-related entity or an entity related to, or that is part of, an operational apparatus with one or more specific functionalities, wherein such entities can be either hardware, a combination of hardware and software, software, or software in execution. As further yet another example, interface(s) can include input/output (I/O) components as well as associated processor, application, or Application Programming Interface (API) components.

It should be understood at the outset that, although exemplary embodiments are illustrated in the figures and described below, the present disclosure should in no way be limited to the exemplary implementations and techniques illustrated in the drawings and described below.

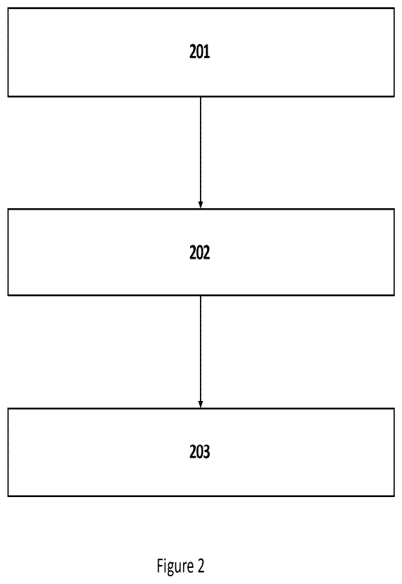

FIG. 2 illustrates method steps to detect exploitation of an AI model (11). The AI model (11) resides in the system (10) as explained in accordance with FIG. 1. The system (10) comprises the AI model (11), a transformation module (12), a media to text AI model (14) and at least a processor (16). It is reiterated that AI model is configured to receive an input prompt (I) and generate a visual media output (A).

Method Step 201 comprises transforming the visual media output (A) into a plurality of secondary outputs (B) by way of a transformation module (12). The transformations include but are not limited to at least one or more of the spatial, pixel, random additive noise transformation. Spatial transformations include rotating, skewing, scaling the visual media output. In the pixel transformations the color, hue, saturation of the visual media output (A) is transformed. In random additive noise transformation, a calculated noise is added across all pixels in the visual media output. Hence the secondary outputs are transformed visual media outputs.

Method step 202 comprises processing the plurality of secondary outputs (B) to generate a plurality of tertiary outputs (C) by way of a media to text AI model (14). The tertiary outputs comprise textual description of the visual media in the secondary output. In other words, the tertiary outputs are textual description of the transformed visual media outputs.

Method step 203 comprises performing comparative analysis on the tertiary outputs (C) and the received input prompts (I) detect exploitation of the AI model by way of a processor (16). The processor (16) can take further reactive measures such as blocking the output on the output interface (20) when exploitation of the AI model is detected.

The processor (16) while performing the comparative analysis uses a multi-label classifier that is trained classify the multi-labels based on the important key words in the textual description of the secondary output (B) and the input prompts (I). For example, an input prompt (I) says “A bird sitting on a tree”. Now for this prompt the processor (16) has the following analysis-Class: Bird, Confidence: 0.998, Class: Tree, Confidence: 0.991, Class: Chair, Confidence: 0.453. Now while analyzing the textual description of the secondary output (B) it will look for classes bird and tree as the most important keywords. If the textual description of the secondary output (B) lacks the keywords bird or tree, it will conclude that there has been an exploitation of the AI model.

The processor while performing comparative analysis is further configured to perform loss calculation, word error rate and similarity measure on the textual description and input prompts (I). Loss calculation and word error rate measure the qualitative and quantitative differences between the input prompt and tertiary output (C) (i.e. textual description of the secondary output (B)). For example, let the input prompt be “A bird sitting on a tree” and the tertiary output be “An eagle sitting on a tree”, here there are two words substitutions (a-an, bird-eagle) hence the word error rate would be 2/6. The loss calculation measures the loss per word and as whole for example the loss between bird vis-à-vis eagle would be less as they belong to the same class. The similarity measure calculates the loss in a 3-D spatial vector space and is plotted graphically.

The core idea behind this disclosure is that for non-manipulative input prompts or for prompts that do not look to exploit the AI model (11), the textual description of the transformed visual media output (A) will not substantially differ from the input prompts (I). The transformations on the visual media output (A) enhances those hidden features which are characteristic of an attack vector/attempt at exploitation of AI model. These features then get reflected in the textual description. Finally, processor (16) compares the original input prompt (I) with textual description. If any anomalies or substantial differences are found, the processor (16) concludes there's an attempt to exploit the AI model. In an embodiment of the present disclosure, the processor (16) also monitor attack patterns for future reference.

The proposed system and method has a multiple real-world use cases of critical importance. Content Generation Platforms: Content generation platforms that use AI models to create articles, images, or videos based on user inputs can use this system to ensure that the content generated is not being exploited or manipulated. It can help maintain the integrity of the content generation process, ensuring that the generated content is in line with the user's original intent and free from manipulation. Social Media Platforms: Social media platforms that use AI to generate image or video descriptions can employ this system to prevent malicious users from exploiting the AI to generate inappropriate or misleading content. This technology can safeguard the platform's content quality, ensuring that user-generated media descriptions align with the actual content and adhere to platform guidelines.

A person skilled in the art will appreciate that while these method steps describes only a series of steps to accomplish the objectives, these methodologies may be implemented with modifications to the system (10) described herein. It must be understood that the embodiments explained in the above detailed description are only illustrative and do not limit the scope of this disclosure. Any variation and adaptation to the system (10) and method to detect exploitation of an AI model are envisaged and form a part of this disclosure. The scope of this disclosure is limited only by the claims.

What is claimed is:

1. A system to detect exploitation of an AI model, said AI model configured to receive an input prompt and generate a visual media output, the system comprising:
a transformation module configured to transform the visual media output into a plurality of secondary outputs;
a media to text AI model configured to:
receive the plurality of secondary outputs; and
process the plurality of secondary outputs to generate a plurality of tertiary outputs; and
a processor configured to:
perform comparative analysis on the tertiary outputs and the received input prompts; and
detect exploitation of the AI model based on the comparative analysis.

2. The system to detect exploitation of an AI model as claimed in claim 1, wherein the transformations include but are not limited to at least one or more of the spatial, pixel, random additive noise transformation.

3. The system to detect exploitation of an AI model as claimed in claim 1, wherein the tertiary outputs comprise textual description of the visual media in the secondary output.

4. The system to detect exploitation of an AI model as claimed in claim 1, wherein the processor while performing the comparative analysis uses a multi-label classifier that is trained classify the multi-labels based on the important key words in the textual description of the secondary output and the input prompts.

5. A method to detect exploitation of an AI model, said AI model configured to receive an input prompt and generate a visual media output, the method comprising:
transforming the visual media output into a plurality of secondary outputs by way of a transformation module;
processing the plurality of secondary outputs to generate a plurality of tertiary outputs by way of a media to text AI model; and
performing comparative analysis on the tertiary outputs and the received input prompts to detect exploitation of the AI model by way of a processor.

6. The method to detect exploitation of an AI model as claimed in claim 5, wherein the transformations include but are not limited to at least one or more of the spatial, pixel, random additive noise transformation.

7. The method to detect exploitation of an AI model as claimed in claim 5, wherein the tertiary outputs comprise textual description of the visual media in the secondary output.

8. The method to detect exploitation of an AI model as claimed in claim 5, wherein the processor while performing the comparative analysis uses a multi-label classifier that is trained classify the multi-labels based on the important key words in the textual description of the secondary output and the input prompts.

9. The method to detect exploitation of an AI model as claimed in claim 5, wherein the processor while performing comparative analysis is further configured to perform loss calculation, word error rate and similarity measure on the textual description and input prompts.
